(19) United States
(12) Patent Application Publication
(10) Pub. No.: US 2024/0061001 A1
(43) Pub. Date: Feb. 22, 2024

(54) CLINICAL LABORATORY AUTOMATION SYSTEM WITH SINGLE CALIBRATOR

(71) Applicants: Beckman Coulter, Inc., Brea, CA (US); DH TECHNOLOGIES DEVELOPMENT PTE. LTD., Singapore (SG)

(72) Inventors: Takayuki MIZUTANI, Edina, MN (US); Thomas W. ROSCOE, Prior Lake, MN (US); John J. BLACKWOOD, Naples, FL (US)

(21) Appl. No.: 18/269,668

(22) PCT Filed: Nov. 23, 2021
(86) PCT No.: PCT/US2021/060528

§ 371 Date: Jun. 26, 2023

Related U.S. Application Data
(60) Provisional application No. 63/131,927, filed on Dec. 30, 2020.

(51) Int. Cl. G01N 35/00; G01N 35/10

(52) U.S. Cl. CPC G01N 35/00693; G01N 35/1016; G01N 2035/00702

(57) ABSTRACT

An external calibration curve relies on external calibrators containing known concentrations of a target analyte that can deteriorate over time, leading to inaccurate results. Generating new calibration curves often requires preparing several calibrators to obtain calibration points needed for generating the calibration curves. Preparing the calibrators necessary for multi-point calibration curves requires operator preparation time and can introduce handling errors. The presently claimed and described technology provides a clinical laboratory automation system, including a fluid handling system, an analyzer component, and a mass spectrometer. The clinical laboratory automation system can provide automated calibration using one calibrator to prepare one or more calibrator dilutions used to generate a calibration curve for the quantitative measurement of a target analyte in a sample. The clinical laboratory automation analyzer may also provide an automated evaluation of pipettor dispensing volume and adjustment of the pipettor actuator to deliver an accurate dispensing volume.

### RELATED APPLICATIONS

The present patent application claims the priority benefit of U.S. Provisional Patent Application Ser. No. 63/131,927, filed Dec. 30, 2020, the content of which is hereby incorporated by reference in its entirety into this disclosure.

### FIELD

Various aspects of the present disclosure relate to an automated calibration using one calibrator to prepare one or more calibrator dilutions used to generate a calibration curve for the quantitative measurement of a target analyte in a sample. Other aspects of the invention provide an automated evaluation of pipettor dispensing volume and adjustment of the pipettor actuator to deliver an accurate dispensing volume.

### BACKGROUND

Mass Spectrometry (MS) is an analytical technique used for determining the elemental composition of samples, quantifying the mass of particles and molecules, and elucidating the chemical structure of molecules. Various types of MS with high specificity, such as Liquid Chromatography (LC-MS), Gas Chromatography (GC-MS), and Matrix-Assisted Laser Desorption/Ionization/Time-Of-Flight (MALDI-TOF MS), are increasingly being used in clinical diagnostics. These MS techniques overcome many of the limitations of immunoassays (e.g., non-specific binding and cross-reactivity of analytes) and offer many advantages).

Quantitation by MS can be performed using an external calibration curve. An external calibration curve relies on external calibrators containing known concentrations of a target analyte. These calibrators can deteriorate over time, leading to inaccurate results. Generating new calibration curves often requires preparing several calibrators to obtain calibration points needed for generating the calibration curves. Preparing the calibrators necessary for multi-point calibration curves requires operator preparation time and can introduce handling errors. For example, some assays require at least a five-point external calibration curve.

Embodiments of the invention address these calibration challenges and other challenges, individually and collectively.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

One aspect provides an automated calibration using one calibrator to prepare one or more calibrator dilutions used to generate a calibration curve for the quantitative measurement of a target analyte in a sample. Some aspects of the invention provide an automated evaluation of pipettor dispensing volume and adjustment of the pipettor actuator to deliver an accurate dispensing volume.

Other aspects are directed to a clinical laboratory automation system comprising: (i) a fluid handling system comprising a container handler, at least one fluid container, and a pipettor arrangement, (ii) an analyzing component, and (iii) a mass spectrometer. The fluid handling system is configured to dispense at least one fluid from the pipettor arrangement into the at least one fluid container. The mass spectrometer is configured to evaluate at least a characteristic of the at least one fluid, and thereby produce a corresponding set of values. The corresponding set of values can be used to calibrate the analyzing component. The clinical laboratory automation system can include a control system configured to control the fluid handling system, the analyzer component, and the mass spectrometer.

Some aspects may include an integrated clinical laboratory automation system that includes an analyzing component that is integrated with a mass spectrometer and a fluid handling system that is integrated with the analyzing component and/or the mass spectrometer. In some embodiments, the analyzing component includes an immunoassay analyzer, a clinical chemistry analyzer, a protein chemistry analyzer, a hematology analyzer, or a urinalysis analyzer.

Another aspect is directed to a method of calibrating an immunoassay analyzer or a clinical chemistry analyzer, the method being performed by a clinical laboratory automation system comprising (i) a fluid handling system comprising a container handler, at least one fluid container, and a pipettor arrangement, (ii) an analyzer component, and (iii) a mass spectrometer. In one embodiment, the method comprises dispensing, from a first pipettor in the pipettor arrangement of the fluid handling system, a first requested volume of a diluent fluid into a fluid container, and dispensing, from a second pipettor in the pipettor arrangement of the fluid handling system, a second requested volume of a calibrator into the same fluid container to produce a dilution series comprising at least one dilution of the calibrator; performing, by the mass spectrometer, an evaluation of the concentration of at least one dilution of the calibrator from the dilution series, and generating a corresponding set of values to thereby generate an RLU-dose calibration curve; and calibrating the immunoassay analyzer or clinical chemistry analyzer using, at least in part, the RLU-dose calibration curve. In an alternative method, the immunoassay analyzer or clinical chemistry analyzer includes an RLU-dose master calibration curve, and the corresponding values are used to adjust the RLU-dose master calibration curve to thereby calibrate the immunoassay analyzer or clinical chemistry analyzer.

A further aspect is directed to a method of calibrating an immunoassay analyzer or a clinical chemistry analyzer, the method being performed by a clinical laboratory automation system comprising (i) a fluid handling system comprising a container handler, at least one fluid container, and a pipettor arrangement, (ii) a sample pipettor station, (iii) an analyzer component, and (iv) a mass spectrometer. The method comprises dispensing, from a first pipettor in the pipettor arrangement of the fluid handling system, a first requested volume of a diluent fluid into a fluid container, and dispensing, from the sample pipettor station, a requested volume of a calibrator into the same fluid container to produce a dilution series comprising at least one dilution of the calibrator; performing, by the mass spectrometer, an evaluation of the concentration of at least one dilution of the calibrator from the dilution series, and generating a corresponding set of values to thereby generate an RLU-dose calibration curve; and calibrating the immunoassay analyzer or clinical chemistry analyzer using, at least in part, the RLU-dose calibration curve.

Another aspect is directed to a method of adjusting a pipettor dispensing volume, the method being performed by a clinical laboratory automation system comprising (i) a fluid handling system comprising a container handler, at least one fluid container, and a pipettor arrangement comprising at least a first pipettor and a second pipettor, and at least one pump driven by an actuator and associated with the first and/or second pipettor, (ii) an analyzer component, and (iii) a mass spectrometer. The method comprises dispensing from the first pipettor a first requested volume of a first diagnostic reagent comprising an analyte into a fluid container, and dispensing from the second pipettor a second requested volume of a second diagnostic reagent comprising an antibody into the same fluid container; quantifying, by the mass spectrometer, the mixture of diagnostic reagents and generating a corresponding set of values; evaluating for pipettor dispensing inaccuracies using at least the corresponding set of values; and, if dispensing inaccuracies are determined, adjusting the actuator as necessary to dispense accurate pipettor dispensing volumes.

Another aspect is directed to a method for providing a variable dilution of a fluid, the method being performed by a clinical laboratory automation system comprising a fluid handling system comprising a container handler, at least a first fluid container, and a pipettor arrangement comprising at least a first pipettor and a second pipettor, the fluid handling system configured to produce a set of dilution series of a calibrator. The method comprises providing a calibrator, providing a diluent, dispensing from the first pipettor a first requested volume of the diluent into the first fluid container, and dispensing from the second pipettor a first requested volume of the calibrator into the same fluid container.

A further aspect is directed to a method for providing a variable dilution of a fluid, the method being performed by a clinical laboratory automation system comprising a sample pipettor station, and a fluid handling system comprising a container handler, at least a first fluid container, and a pipettor arrangement comprising at least a first pipettor, the fluid handling system configured to produce a set of dilution series of a calibrator. The method comprises providing a calibrator, providing a diluent, dispensing from the first pipettor a first requested volume of the diluent into the first fluid container, and dispensing from the sample pipettor station a requested volume of the calibrator into the same fluid container.

These and other embodiments of the invention are described in further detail below, with reference to the drawings.

### BRIEF DESCRIPTION OF THE FIGURES

Embodiments of the present disclosure will now be described, by way of example only, with reference to the attached Figures, wherein:

FIG. 1 shows a block diagram of a clinical laboratory automation system according to an embodiment of the invention.

FIG. 2A shows a diagram of an analyzer component in a clinical laboratory automation system according to an embodiment of the invention.

FIG. 2B shows a diagram of an alternative embodiment of an analyzer component in a clinical laboratory automation system according to another embodiment of the invention.

FIG. 3 shows an illustrative flow chart diagram showing operating procedures for operating the fluid handling system to prepare a calibration dilution series.

FIG. 4 shows an illustrative flow chart diagram showing operating procedures for operating the fluid handling system to prepare a reagent mixture for evaluating pipettor dispensing volumes.

FIG. 5 shows a block diagram of a mass spectrometer.

FIG. 6 shows a portion of a mass spectrometer using an electrospray method.

FIG. 7 shows a structure of an ion detector used in a mass spectrometer.

FIG. 8 shows a flowchart illustrating a calibration curve forming process according to an embodiment of the invention.

FIG. 9 shows a flowchart illustrating a process for evaluating and adjusting pipettor dispensing volumes according to an embodiment of the invention.

FIG. 10A shows how the calibration signals of a single Thyroid-Stimulating Hormone calibrator dilution curve can deteriorate over time.

FIG. 10B shows a single Thyroid-Stimulating Hormone calibration dilution curve prepared according to an embodiment of the invention.

FIG. 10C shows an adjustment of a Master Calibration Curve according to an alternative embodiment of the invention.

FIG. 11 shows a diagnostic reagent analysis on a mass spectrometer.

### DETAILED DESCRIPTION

Various embodiments will be described in detail with reference to the drawings, wherein like reference numerals represent like parts and assemblies throughout the several views. It is to be understood that this disclosure is not limited to the particular methodology, protocols, and reagents described herein and as such may vary. It is also to be understood that the terminology used herein is for the purpose of describing particular embodiments only and is not intended to limit the scope of the present disclosure or the appended claims.

As used herein and in the appended claims, the singular forms “a,” “an,” and “the” include plural reference unless the context clearly indicates otherwise.

Unless defined otherwise, all technical and scientific terms used herein have the same meaning as commonly understood to one of ordinary skill in the art to which this disclosure belongs.

Some embodiments may be used to calibrate analyzers used to detect the presence, absence, or concentration of analytes in biological or chemical samples. Biological samples such as biological fluids may include, but are not limited to, blood, plasma, serum, or other bodily fluids or excretions, such as but not limited to saliva, urine, cerebrospinal fluid, lacrimal fluid, perspiration, gastrointestinal fluid, amniotic fluid, mucosal fluid, pleural fluid, sebaceous oil, exhaled breath, and the like. Chemical samples may include any suitable types of samples including chemicals, including water samples.

Prior to discussing several embodiments, some terms may be described in further detail.

The term “analyzer” or “analyzing component” may include any suitable instrument that is capable of analyzing a constituent, fluid, or sample such as a biological sample. Examples of analyzers or analyzing components include mass spectrometers, immunoassay analyzers, hematology analyzers, microbiology analyzers, and/or molecular biology analyzers.

In some embodiments, the analyzer can be an immunoassay analyzer (typically detecting a label (chemoluminescent, electrochemiluminescent fluorescent, radioactive, isotope, DNA, etc.) or label-free system. Other types of analyzers may include hematology analyzers, microbiology analyzers, chemistry analyzers, urine analyzers, biochemical analyzers, and/or molecular biology analyzers. When analyzing a biological sample, one or more of these types of analyzers, in any suitable combination, may be used to analyze the biological sample.

A hematology analyzer can be used to perform complete blood counts, erythrocyte sedimentation rates (ESRs), and/or coagulation tests. Automated cell counters sample the blood, and quantify, classify, and describe cell populations using both electrical and optical techniques.

A microbiology analyzer can function as a diagnostic tool for determining the identity of a biological organism. In some embodiments, a microbiology analyzer can identify an infecting microorganism. Such analyzers can use biochemicals in a plurality of small sample test microwells in centrifugal rotors that contain different substrates or in multi-well panels, depending on the type of test being performed.

A molecular biology analyzer can be a device that can analyze a biological sample at its molecular level. An example of a molecular biology analyzer may include a nucleic acid analyzer such as a DNA analyzer.

A chemistry analyzer can run assays on clinical samples such as blood serum, plasma, urine, and cerebrospinal fluid to detect the presence of analytes relating to disease or drugs. A chemistry analyzer may use photometry. In photometry, a sample is mixed with the appropriate reagent to produce a reaction that results in a color. The concentration of the analyte determines the strength of color produced. The photometer shines a light of the appropriate wavelength at the sample and measures the amount of light absorbed, which is directly correlated to the concentration of the analyte in the sample. Another analytical method used in a chemistry analyzer is the use of ion selective electrodes (ISE) to measure ions such as Na⁺, K⁺, Ca⁺, F⁻, Cl⁻, and Li⁺. An ISE is a sensor that determines the ions' concentration in a solution by measuring the current flow through an ion selective membrane.

The term “analyte” may include a substance whose presence, absence, or concentration is to be determined according to embodiments of the present invention. Typical analytes may include, but are not limited to organic molecules, hormones (such as thyroid hormones, estradiol, testosterone, progesterone, estrogen), metabolites (such as glucose or ethanol), proteins, lipids, carbohydrates, and sugars, steroids (such as Vitamin D), peptides (such as procalcitonin), nucleic acid segments, biomarkers (pharmaceuticals such as antibiotics, benzodiazepine), drugs (such as immunosuppressant drugs, narcotics, opioids, etc.), molecules with a regulatory effect in enzymatic processes such as promoters, activators, inhibitors, or cofactors, microorganisms (such as viruses (including EBV, HPV, HIV, HCV, HBV, Influenza, Norovirus, Rotavirus, Adenovirus, etc.), bacteria (H. pylori, Streptococcus, MRSA, C. diff, Ligionella, etc.), fungus, parasites (plasmodium, etc.), cells, cell components (such as cell membranes), spores, nucleic acids (such as DNA and RNA), etc. Embodiments of the invention can also allow for the simultaneous analysis of multiple analytes in the same class or different classes (e.g., simultaneous analysis of metabolites and proteins). In embodiments of the invention, the analysis of a particular analyte, such as a biomarker, may indicate that a particular condition (e.g., disease) is associated with a sample that contains the analyte.

The term “immunoassay” refers to a laboratory method used to determine the amount of an analyte in a sample. It can be based on the interaction of antibodies with antigens and, because of the degree of selectivity for the analyte (either antigen or antibody), an immunoassay can be used to quantitatively determine very low concentrations of analyte in a test sample. An “immunoanalyzer” or “immunoassay analyzer” can include an instrument on which immunoassays have been automated. Various immunoassay analyzers are commercially available including the Dx1™ system (Beckman Coulter, CA), the AD VIA™ and CENTAUR™ systems (Siemens Healthcare, Germany), the COB ASTM system (Roche Diagnostic, Germany), the ARCHITECT™ system (Abbott, IL), the VITROS™ system (Ortho-clinical Diagnostic, NJ), and the VIDAS™ system (Biomerieux, France).

A “mass spectrometer” is an instrument that can measure the masses and relative concentrations of atoms and molecules. One example of a mass spectrometer makes use of the basic magnetic force on a moving charged particle. Basically, the instrument ionizes a sample and then deflects the ions through a magnetic field based on the mass-to-charge ratio of the ion. The mass spectrum can then be used to determine the elemental or isotopic signature of a sample, the masses of particles and of molecules, and to elucidate the chemical structures of molecules, such as peptides and other chemical compounds. Commercially available mass spectrometers can be categorized based on how they sector mass selection, including time-of-flight, quadrupole MS, ion traps (including 3D quadrupole, cylindrical ion traps, linear quadropole ion traps, orbitraps), Fourier transform ion cyclotron resonance (FTMS), etc. Alternatively, they can be sectored based on ion source (laser desorption, matrix assisted laser desorption, thermal ionization, plasma, spark source, etc.) or detectors (electron multipliers (such as Faraday cups and ion-to-photon detectors), inductive detectors, etc.). In a preferred embodiment, the mass spectrometer can be a triple quadrupole mass spectrometer.

The term “calibration” refers to a process for determining the relationship between an instrument response (measured response) and known analyte concentrations to ensure valid quantitation of a sample.

The term “calibration curve” refers to the mathematical relationship between the measured response and the known analyte concentrations. The calibration curve is used to convert Relative Light Unit (RLU) measurements of samples to specific quantitative analyte concentrations.

In the specific examples provided below, a clinical laboratory automation system, including a fluid handling system, an immunoassay analyzer, and a mass spectrometer, is described in detail. However, embodiments of the invention are not limited thereto. Instead of an immunoassay analyzer, another type of analyzer, such as a chemistry analyzer, can be used instead of the immunoassay analyzer. Many of the functions and features in the immunoassay analyzer may also be present in the chemistry analyzer (e.g., reagent storage, aliquoting station, sample preparation station, etc.). Further, additional components such as a sample introduction apparatus may also be used with the chemistry analyzer and the mass spectrometer in the clinical laboratory automation system.

Specific embodiments may include a fluid handling system that can be separate from or integrated with the analyzing component. The fluid handling system can also be separate from or at least partially integrated with the mass spectrometer. In some embodiments, the fluid handling system, analyzing component, and mass spectrometer are individual components in a modular laboratory automation system. The modular laboratory automation system may have a workflow that includes a pre-analytical portion, a post-analytical portion, and at least one connection to the analyzing component. The pre-analytical portion may include batch loading components, at least one centrifuge, and/or a sample quality detection component. The pre-analytical portion may also include a fluid handling system. The post-analytical portion may include a volume detection component and/or a storage and retrieval component. The retrieval can be automated or manual. A direct-track sampling can be used to connect to, for example, an immunoassay analyzer or coagulation instrument. A rack-builder unit can be used to connect to, for example, a clinical chemistry analyzer or hematology analyzer. The mass spectrometer can be off-line from the workflow or connected through other analytical connectors know in the art.

In some embodiments, the fluid handling system, analyzing component, and the mass spectrometer can be a completely integrated platform. In some embodiments, the fluid handling system is part of a sample preparation station. In some embodiments, the automation system includes a sample introduction station that can transfer samples to the mass spectrometer for analysis. The clinical laboratory automation system also comprises a control system that can control the fluid handling system, the analyzer component, and the mass spectrometer.

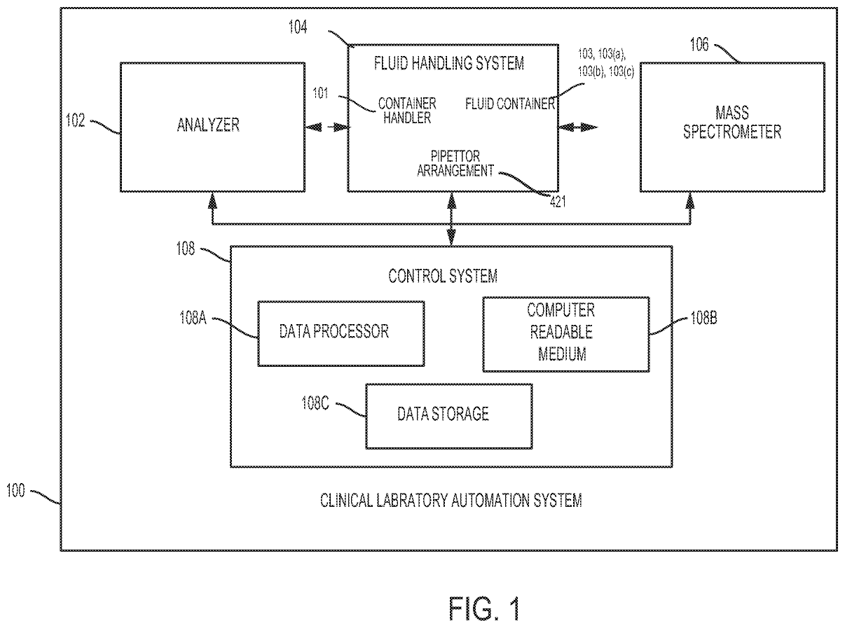

FIG. 1 shows a high-level block diagram of a clinical laboratory automation system according to an embodiment of the invention. The clinical laboratory automation system 100 comprises an analyzer component (e.g., an immunoassay analyzer) 102, a mass spectrometer 106, and a fluid handling system 104. The fluid handling system 104 may be integrated with a sample processing system in some embodiments. An automated sample processing system is described in detail in published PCT Application No. WO2018/217778, published Nov. 29, 2018, which is incorporated herein by reference in its entirety. The fluid handling system 104 may be physically and/or operationally coupled to the analyzer 102 and the mass spectrometer 106, and in some embodiments, the fluid handling system 104, the analyzer component 102, and the mass spectrometer 106 may form a single instrument. The fluid handling system 104 may serve to prepare calibrator dilutions for quantitative calibration of the analyzer component and/or prepare reagent mixtures for evaluating pipettor dispensing volumes. Calibrator dilutions and reagent mixtures may be transferred to the mass spectrometer 106 for analysis.

The analyzer component 102 may include an immunoassay analyzer, a clinical chemistry analyzer, a protein chemistry analyzer, a hematology analyzer, or a urinalysis analyzer. The analyzer component 102 may include a number of sample aliquot processing apparatuses to form processed sample aliquots for analysis. Such processing apparatuses may process a sample or sample aliquot in any suitable manner. Examples of sample aliquot processing apparatuses include reagent addition stations (e.g., reagent pipetting stations), sample pipetting stations, incubators, wash stations (e.g., a magnetic wash station), sample storage units, etc. The analyzer component 102 may be an automated analyzer component 400.

A control system 108 can also be present in the clinical laboratory automation system 100. The control system 108 can control the analyzer component 102, the fluid handling system 104, and/or the mass spectrometer 106. The control system 108 may comprise a data processor 108A, and a non-transitory computer-readable medium 108B, and a data storage 108C coupled to the data processor 108A. The non-transitory computer-readable medium 108B may comprise code, executable by the data processor 108A, to perform the functions described herein. The data processor 108C may store data for processing samples, sample data, or data for analyzing sample data.

The data processor 108A may include any suitable data computation device or combination of such devices. An exemplary data processor may comprise one or more microprocessors working together to accomplish a desired function. The data processor 108A may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Apple's Ml, Intel's Celeron, Itanium, Pentium, Xeon, and/or XScale; and/or the like processor(s).

The computer-readable medium 108B and the data storage 108C may be any suitable device or devices that can store electronic data. Examples of memories may comprise one or more memory chips, disk drives, etc. Such memories may operate using any suitable electrical, optical, and/or magnetic mode of operation.

The computer-readable medium 108B may comprise code, executable by the data processor 108A to perform any suitable method. For example, the computer-readable medium 108B may comprise code, executable by the processor 108A, to cause the clinical laboratory automation system to automatically generate a calibration curve using measurements of the calibration dilutions from the mass spectrometer 106. In other embodiments, the computer-readable medium 108B may comprise code, executable by the data processor 108A, to cause the clinical laboratory automation system to perform a method comprising: causing the fluid handling system to prepare a reagent mixture, such as a mixture of an analyte and an antibody or antigen, used to evaluate, based on molecular weight shift, whether inaccuracies in pipettor dispensing volume are present. If inaccuracies are detected, the data processor 108A may cause the fluid handling system 104 to adjust the dispensing volume of the pipettor.

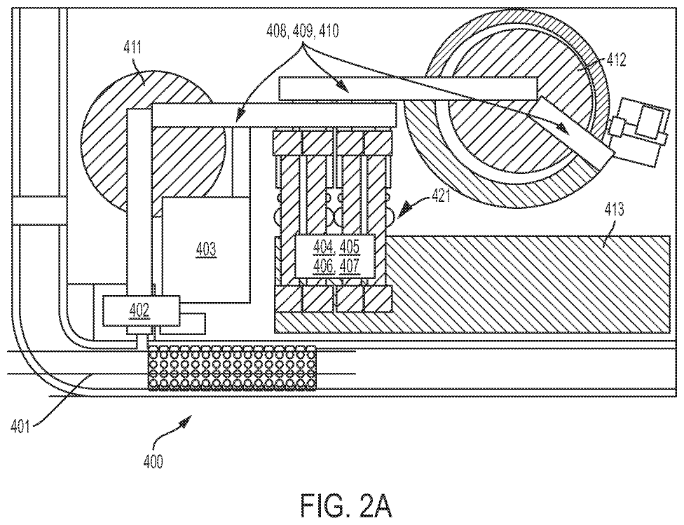

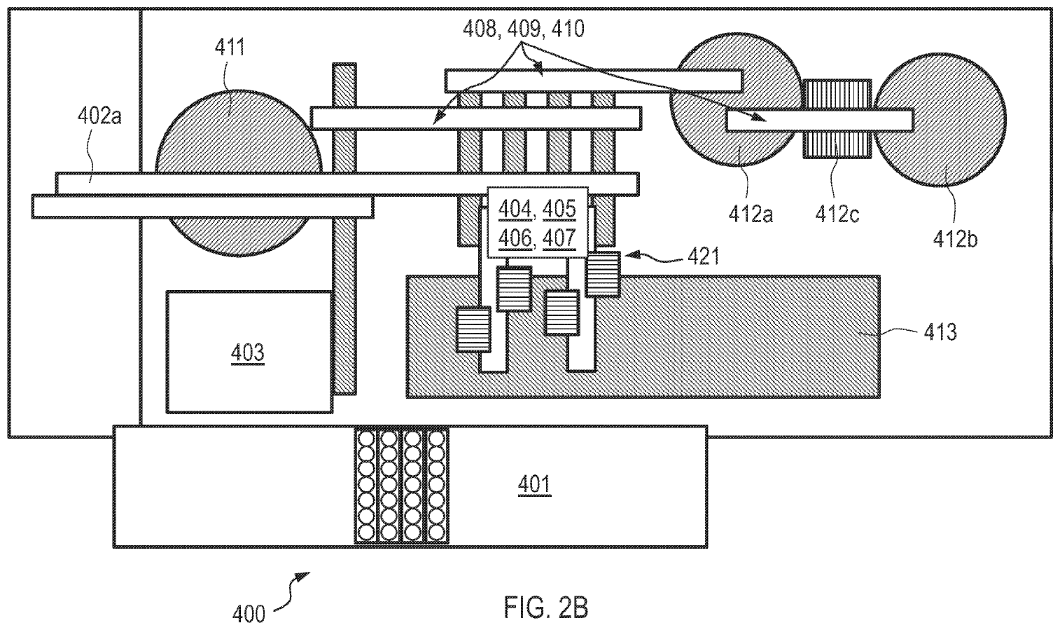

The fluid handling system 104 comprises a container handler 101, at least one fluid container 103, and a pipettor arrangement 421. The container handler 101 can be any apparatus used to handle or transport a container. Examples of suitable container handlers include, but are not limited to, pick-and-place devices, such as pick-and-place transfer gantrys, transfer shuttles, such as extended linear reaction shuttles, or combinations of pick-and-place transfer gantrys and extended linear reaction shuttles. The fluid container 103 can be a cuvette, a tube, a vial, wells in a pack, etc. In some embodiments, the fluid handling system 104 comprises multiple fluid containers 103, 103a, 103b, 103c, such as two containers, three containers, or four or more containers. The pipettor arrangement 421 includes at least one pipettor 404 (see FIGS. 2A and B) that dispenses a measured volume of at least one fluid into the fluid container 103. In some embodiments, the pipettor arrangement 421 may include a second pipettor 405, or may have more than two pipettors. Each pipettor may include an ultrasonic transducer and a probe. The ultrasonic transducer applies ultrasonic vibrations to the probe's tip to mix reagents in a reagent pack, mix the contents in the fluid container, clean the probe after each use, and sense the level of fluid in the fluid container. Each pipettor may also include a fluid pump 414 and associated valve to aspirate diluents, calibrators, and reagents into the probe. The fluid pump 414 may be driven by an actuator 415, such as a motor. In some embodiments, the motor is a stepper motor that permits precise adjustment of the volume of fluid dispensed by the pipettor.

The fluids dispensed by the pipettor arrangement 421 can be a calibrator, a diagnostic reagent, a diluent, or a mixture thereof, as well as patient samples. In some embodiments, a separate sample pipettor station may be used to dispense patient samples. The separate sample pipettor may also be used to dispense a calibrator in some embodiments. In some embodiments, the calibrator and/or the diagnostic reagent comprises an analyte. Examples of analytes that can be analyzed in the clinical laboratory automation system include thyroid-stimulating hormone (TSH), prostate-specific antigen (PSA), troponin, vitamin D, and Free thyroxine (T4). The diagnostic reagent may also comprise an antibody or antigen. Diluents that can be used to prepare calibrator dilutions or patient samples include TRIS buffer and Bovine Serum Albumin (BSA) buffer.

FIG. 2A shows a block diagram of an automated analyzer component 400 that can be used in a clinical laboratory automation system according to an embodiment. The basic structural and functional modules of the automated analyzer component 400 can include a sample presentation unit 401, an aliquoting station comprising a main sample pipetting station 402, a bulk vessel feeder 403, a fluid handling system, including a pipettor arrangement 421 that may include a first pair of dual reagent pipettors 404 and 405, and a second pair of dual reagent pipettors 406 and 407, a container handler that may include a first pick-and-place gripper 408, a second pick-and-place gripper 409, and a third pick-and-place gripper 410, an incubator/wash/read station 412, a sample storage 411, and a reagent storage 413. Optionally, the sample and/or reagent storage may be chilled. The sample presentation unit 401 may be used to load calibrators and matrix and reagent packs, and transport them to the pipettor arrangement.

One or more of the pipettors 404, 405, 406, 407 of the pipettor arrangement 421 may be used to prepare calibrator dilutions for use in calibrating the analyzer component. The pipettors 404, 405, 406, 407 may also be used to prepare a diagnostic reagent mixture that can be used to evaluate pipettor dispensing volume. The four pipettors 404, 405, 406, 407 may be arranged as two dual pipettors and can be independent of each other. Each of the four pipettors 404, 405, 406, 407 may have its own fluid pumps and valves, watch towers, reaction vessel carriages, and probes. Each of the fluid pumps may be driven by an actuator, such as a motor, preferably a stepper motor. Although four pipettors 404, 405, 406, 407 are illustrated, it is understood that embodiments of the invention can include more or less of the pipettors.

The three pick-and-place grippers 408, 409, 410 may be used to transport sample and reaction vessels (fluid containers) among the various modules of the analyzer component. The first pick-and-place gripper 408 can be used to transport fluid containers between the bulk vessel feeder 403 or the sample storage 411 and the pipettor arrangement 421. The second pick-and-place gripper 409 can be used to transport fluid containers between the pipettor arrangement 421 and the incubator/wash/read station 412. The third pick-and-place griper 410 can be used to transport the fluid containers between the incubator and the wash wheel (an example of a wash station) of the incubator/wash/read station 412. A detailed description of the configurations and functions of the pick-and-place grippers 408, 409, 410 is provided in U.S. Pat. No. 7,128,874, which is herein incorporated by reference in its entirety. It is understood that embodiments of the invention can have more or less pick-and-place grippers. A further detailed description of the automated analyzer component is provided in PCT Published Application No. WO2018/217778, which is herein incorporated by reference in its entirety.

FIG. 2B shows a block diagram of an alternative embodiment of an automated analyzer component 400a, where like numerals represent like structures to those shown in FIG. 2A. In this embodiment, a main sample pipettor station 402a is used not only to dispense patient samples for processing but may also be used to dispense the calibrator used to prepare the calibrator dilutions. In this embodiment, one or more of the pipettors 404, 405, 406, or 407 dispense the reagent(s) used to prepare the calibrator dilutions, and the sample pipettor station 402a dispenses the calibrator. As in the FIG. 2A embodiment, pick-and-place grippers 408, 409, and 410 may be used to transport sample and fluid containers among the various modules of the analyzer component. The assay incubating, washing, and reading steps may be performed in an incubating station 412a, a washing station 412b, and a reading station 412c.

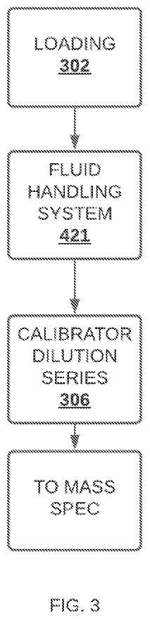

FIG. 3 shows an illustrative flow chart diagram showing the basic operating procedures for operating the fluid handling system to prepare a calibrator dilution series. In the process, and referring to FIGS. 1, 2A, and 2B, an operator loads a matrix pack comprising an appropriate diluent for the assay requiring calibration into the clinical laboratory automation system. The operator also loads a calibrator vial, or other fluid container, containing a high concentration of an appropriate calibrator onto a rack. The calibrator may comprise a single analyte or may comprise multiple analytes. If multiple analytes are present in the calibrator requiring different diluents or reagents, the different diluents or reagents may be provided through different wells in the matrix pack. A calibrator card associated with the calibrator provides an identifier, such as a bar code, for each dilution of the calibrator. In some embodiments, an operator hand scans the bar code information to transfer the information to the control system. In a preferred embodiment, the calibration card may be attached directly to the rack so that the analyzer component can read the calibrator information directly and transfer it to the control system 108. The calibrator rack is advanced to the pipettor arrangement 421 where an identifier on the calibrator vial is read to identify the assay(s) requiring calibration. At the same time, the fluid container(s) necessary for preparing the calibration dilutions are delivered to the pipettor arrangement 421 by a container handler, such as pick-and-place gripper 408.

In the pipettor arrangement 421, the number of dilutions required to generate a calibration curve are prepared by dispensing, from one of the pipettors 404, 405, 406, 407, a requested volume of diluent from the matrix pack into a fluid container 103. In the FIG. 2A embodiment, a requested volume of the high concentration calibrator is then dispensed from one of the pipettors 404, 405, 406, 407 into the same fluid container. In the FIG. 2B embodiment, the fluid container 103 is moved from the pipettor arrangement to the main sample pipettor station 402a, which dispenses the requested volume of the high concentration calibrator into the same fluid container. If a second dilution (or more) of the calibrator is required, the second dilution may be prepared in a second fluid container 103a in the same way as the first dilution prepared by the respective embodiment, except that the requested volume of diluent dispensed by the pipettor into the second fluid container 103a is different so that the second dilution of the calibrator is different from the first dilution. Additional calibrator dilutions can be prepared depending on the number of calibration points that are required for the calibration curve for the particular assay. Each prepared dilution has a different concentration of calibrator, resulting in a set or series of calibrator dilutions. An example of a dilution series can be 1/1, 1/2, 1/5, 1/10, 1/15, 1/20. In embodiments, each dilution will fall within the range of 1/1 to 1/200. In some embodiments, each dilution volume is sufficient to run at least three assay repetitions. One set of the dilution series may be transferred to the mass spectrometer 106 for calibrator measurement. The measured values from the mass spectrometer 106 may be used to generate the RLU-Dose calibration curve. The other two dilution series may be transferred to the analyzer component 102 for assay testing.

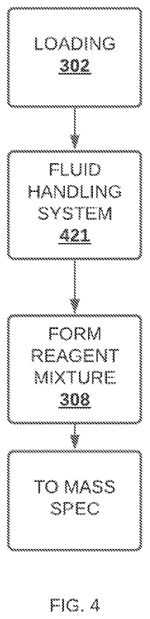

FIG. 4 shows an illustrative flow chart diagram showing the basic operating procedures for operating the fluid handling system to prepare a mixture of diagnostic reagents for use in evaluating pipettor dispensing volume. In the process, and referring to FIGS. 1 and 2A, an operator loads a reagent pack into the clinical laboratory automation system. The reagent pack comprises at least two diagnostic reagents, one diagnostic reagent comprises an analyte, and a second diagnostic reagent comprises an antibody or antigen. The reagent pack is transferred to the pipettor arrangement 421. At the same time, a container handler 101, such as the pick-and-place gripper 408 presents a fluid container to the pipettor arrangement 421 for dispensing the diagnostic reagents into the fluid container 103. With the reagent pack and fluid container 103 in position, a first pipettor, which can be any one of the pipettors 404, 405, 406, 407, dispenses, with a precision pump, a first requested volume of the analyte into the fluid container 103, and a second pipettor, which is another of the pipettors 404, 405, 406 407, dispenses, with a precision pump, a second requested volume of the antibody or antigen into the same fluid container 103. The diagnostic reagents are allowed to immunoreact and form a mixture. The mixture may be transferred to the mass spectrometer for evaluation.

A wide variety of mass analyzer systems, which can form part of the mass spectrometer, can be used in the clinical laboratory automation system according to various embodiments. Suitable mass analyzer systems include two mass separators with an ion fragmentor disposed in the ion flight path between the two mass separators. Examples of suitable mass separators include, but are not limited to, quadrupoles, RF multipoles, ion traps, time-of-flight (TOF), and TOF in conjunction with a timed ion selector. Suitable ion fragmentors include, but are not limited to, those operating on the principles of collision-induced dissociation (CID, also referred to as collisionally assisted dissociation (CAD)), photoinduced dissociation (PID), surface-induced dissociation (SID), post source decay, by interaction with an electron beam (e.g., electron-induced dissociation (BID), electron capture dissociation (BCD)), interaction with thermal radiation (e.g., thermal/black body infrared radiative dissociation (BIRD)), post source decay, or combinations thereof.

Examples of suitable mass spectrometers include, but are not limited to, those which comprise one or more of a triple quadrupole, a quadrupole-linear ion trap (e.g., 4000 Q TRAP® EC/MS/MS System, Q TRAP® LC/MS/MS System), a quadrupole TOF (e.g., QSTAR® LC/MS/MS System), and a TOF-TOF.

The mass spectrometer can comprise a triple quadrupole mass spectrometer for selecting a parent ion and detecting fragment daughter ions thereof. In this embodiment, the first quadrupole selects the parent ion. The second quadrupole is maintained at a sufficiently high pressure and voltage so that multiple low energy collisions occur, causing some of the parent ions to fragment. The third quadrupole is selected to transmit the selected daughter ion to a detector. In various embodiments, a triple quadrupole mass spectrometer can include an ion trap disposed between the ion source and the triple quadrupoles. The ion trap can be set to collect ions (e.g., all ions, ions with specific m/z ranges, etc.) and, after a fill time, transmit the selected ions to the first quadrupole by pulsing an end electrode to permit the selected ions to exit the ion trap. Desired fill times can be determined, e.g., based on the number of ions, charge density within the ion trap, the time between elution of different signature peptides, duty cycle, decay rates of excited state species, multiply charged ions, or combinations thereof.

One or more of the quadrupoles in a triple quadrupole mass spectrometer can be configurable as a linear ion trap (e.g., by the addition of end electrodes to provide a substantially elongate cylindrical trapping volume within the quadrupole). In various embodiments, the first quadrupole selects the parent ion. The second quadrupole is maintained at a sufficiently high collision gas pressure and voltage so that multiple low energy collisions occur, causing some of the parent ions to fragment. The third quadrupole is selected to trap fragment ions and, after a fill time, transmit the selected daughter ion to a detector by pulsing an end electrode to permit the selected daughter ion to exit the ion trap. Desired fill times can be determined, e.g., based on the number of fragment ions, charge density within the ion trap, the time between elution of different signature peptides, duty cycle, decay rates of excited state species, or multiply charged ions, or combinations thereof.

In some embodiments, the mass spectrometer can comprise two quadrupole mass separators and a TOF mass spectrometer for selecting a parent ion and detecting fragment daughter ions thereof. In various embodiments, the first quadrupole selects the parent ion. The second quadrupole is maintained at sufficiently high pressure and voltage so that multiple low energy collisions occur, causing some of the ions to fragment, and the TOF mass spectrometer selects the daughter ions for detection, e.g., by monitoring the ions across a mass range which encompasses the daughter ions of interest and extracted ion chromatograms generated, by deflecting ions that appear outside of the time window of the selected daughter ions away from the detector, by time gating the detector to the arrival time window of the selected daughter ions, or combinations thereof.

In some embodiments, the mass spectrometer can comprise two TOF mass analyzers and an ion fragmentor (such as, for example, CID or SID). In various embodiments, the first TOF selects the parent ion (e.g., by deflecting ions that appear outside the time window of the selected parent ions away from the fragmentor) for introduction in the ion fragmentor and the second TOF mass spectrometer selects the daughter ions for detection, e.g., by monitoring the ions across a mass range which encompasses the daughter ions of interest and extracted ion chromatograms generated, by deflecting ions that appear outside of the time window of the selected daughter ions away from the detector, by time gating the detector to the arrival time window of the selected daughter ions, or combinations thereof. The TOF analyzers can be linear or reflecting analyzers.

The mass spectrometer can comprise a tandem MS-MS instrument comprising a first field-free drift region having a timed ion selector to select a parent ion of interest, a fragmentation chamber (or ion fragmentor) to produce daughter ions, and a mass separator to transmit selected daughter ions for detection. In various embodiments, the timed ion selector comprises a pulsed ion deflector. In various embodiments, the ion deflector can be used as a pulsed ion deflector. The mass separator can include an ion reflector. In various embodiments, the fragmentation chamber is a collision cell designed to cause fragmentation of ions and to delay extraction. In various embodiments, the fragmentation chamber can also serve as a delayed extraction ion source for the analysis of the fragment ions by time-of-flight mass spectrometry.

In some embodiments, ionization can be used to produce structurally specific fragment ions and Q3 MRM ions. A labeling reagent can be wholly or partly contained in the structurally specific fragment ions. The method can provide both sensitivity and specificity for the Q3 MRM ions. In some embodiments, ionization can be used to produce a dominant neutral loss fragment ion, which can be selected in Q3 and then fragmented to produce structurally specific ions. These fragment ions can then be used for identification and quantification in a procedure referred to as MSS.

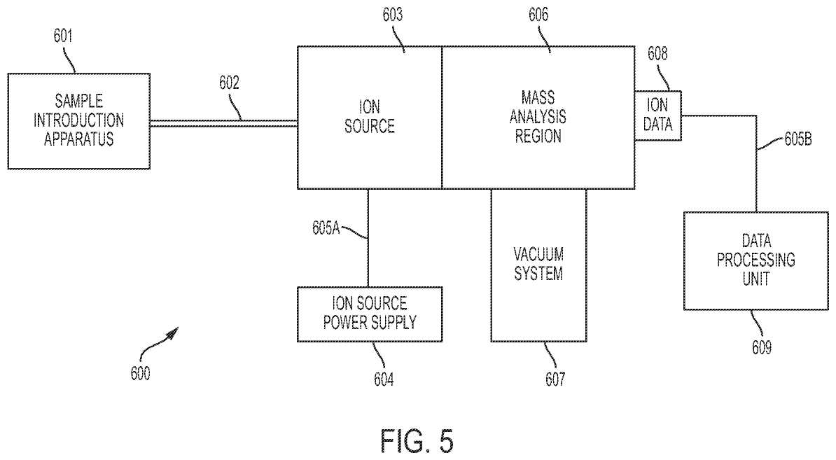

FIG. 5 shows a block diagram of an exemplary mass spectrometer 600 and an introduction apparatus 601 for introducing the calibrator dilutions or diagnostic reagent mixture to the mass spectrometer. The introduction apparatus 601 can be in the analyzer component in some embodiments. The introduction apparatus 601 may be coupled to the mass spectrometer 600 through a connecting tube 602. The introduction apparatus 601 may introduce the calibrator dilutions to the ion source 603 through the connecting tube 602. The ion source 603 can be controlled by an ion source power supply 604 through a signal line 605A. Ions concerning calibrator molecules generated by the ion source 603 are introduced to a mass analysis region 606 and mass analyzed. The mass analysis region 606 is evacuated to a vacuum by a vacuum system 607. The ions thus mass analyzed are detected by an ion detector 608. A detection signal is fed through a signal line 605B to a data processing unit 609. The data processing unit 609 may be a separate unit or may be part of the previously described control system.

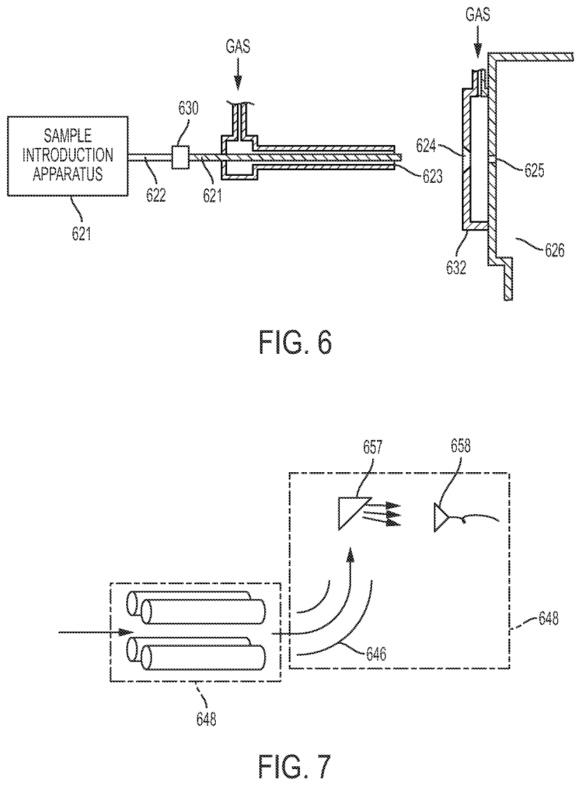

FIG. 6 shows a diagram of a portion of a mass spectrometer using an electrospray method. FIG. 6 is a sectional view showing the structure of an introduction apparatus 619 coupled to an electrospray ion source. A calibrator dilution or reagent mixture provided from the introduction apparatus 619 is introduced through a connecting tube 622 and a connector 630 into a capillary 621 for nebulization. By application of a voltage of the order of kV between the nebulization capillary 621 and a counter electrode 632, small charged droplets of the calibrator dilution or reagent mixture are conically nebulized from an end of the nebulization capillary, that is, a so-called electrospray phenomenon occurs. In the electrospray method, an output 623 for nebulizing gas is provided so that gas such as nitrogen gas is poured from the surroundings of the nebulization capillary 621, thereby to accelerate the vaporization of the small charged droplets. Further, the gas such as nitrogen gas is blown toward the generated small charged droplets from an outlet 624 for vaporizing gas provided in the counter electrode 632 side to accelerate the vaporization of the small charged droplets. Ions generated are introduced through an ion sampling aperture 625 into a vacuum 626 and mass analyzed by a mass analysis region 626 under a high vacuum.

FIG. 7 shows a structure of an ion detector. The structure shown in FIG. 7 can be used to improve the signal-to-noise ratio (SIN) in the mass spectrometer. An ion deflecting electrode 646 can be provided in the rear portion of a mass analysis region 648 for mass separation under a high-frequency electric field to deflect mass-separated ions. The deflected ions are accelerated at a voltage of the order of kV and collide with a dynode 657 to produce secondary electrons. Secondary electrons are emitted from the secondary electron-producing dynode 657 with which the ions collide. The emitted secondary electrons are detected by an electron detector 658 such as an electron multiplier. By the structure shown in FIG. 7, neutral molecules having no charge, charged droplets, or droplets having no charge are prevented from being detected as a signal by the ion detector 648, so that improvement in S/N is attained.

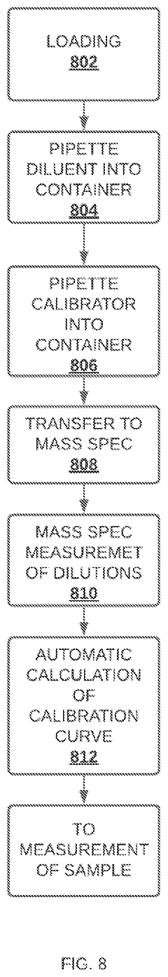

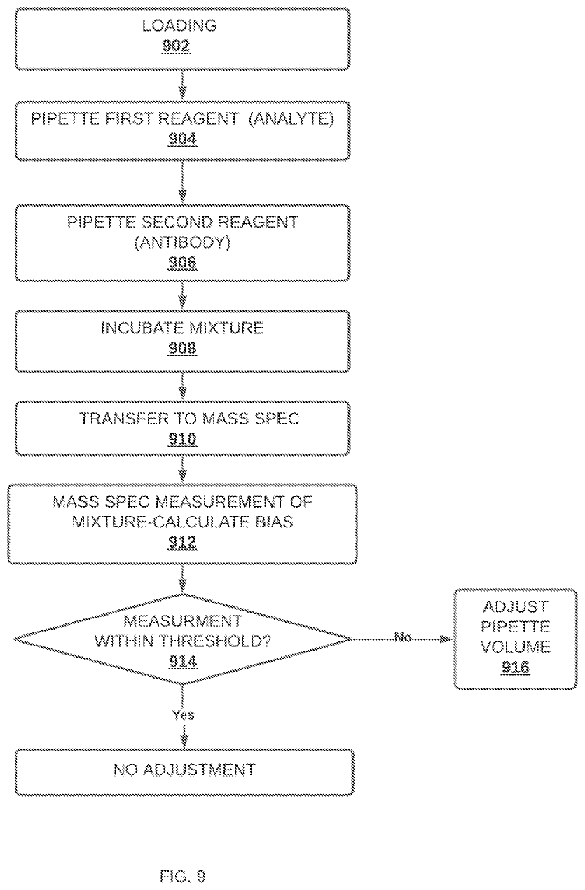

FIG. 8 shows a flowchart illustrating process steps for generating a calibration curve according to an exemplary embodiment. Reference can be made with respect to the automated analyzer component in FIGS. 2A and 2B. In step 802, a matrix pack and calibrator are loaded into the presentation unit 401 in the automated analyzer component 400. In step 804, one of the pipettors 404, 405, 406, 407 delivers a requested volume of diluent into a fluid container 103 provided by the bulk vessel feeder 403. In step 806, the same pipettor or another of the pipettors 404, 405, 406, 407 in the FIG. 2A embodiment of the automated analyzer component delivers a requested volume of the calibrator into the same fluid container 103. In the FIG. 2B embodiment, step 806 of dispensing the calibrator is accomplished by the sample pipettor station 402a. Steps 804 and 806 are repeated for each calibrator dilution to be prepared. In step 808, the series of calibrator dilutions are transferred to the mass spectrometer 106 for measurement. In step 810, the measured values from the mass spectrometer 106 are used to generate the RLU-Dose calibration curve automatically. Thereafter, an actual sample may be analyzed in the analyzer component 102 based on the calibration curve generated in step 810, so that the quantitative value of the analyte in the sample can be obtained.

It should be appreciated that, depending on the particular assay test to be calibrated, additional process steps may be needed to be performed. For example, magnetic beads or particles may be added, and incubation, separation, and/or washing steps may be performed. Other processing steps may include immunopurification processing steps. In an immunopurification process, after the analyte is captured by the antibody, any unbound molecules are washed away in a washing process. In a subsequent elution step, the analyte is subsequently released from the antibody using a buffer and an eluent. The eluent containing the “purified” target can be characterized as a processed sample aliquot, which is then collected and analyzed by the mass spectrometer. Other processing steps may include protein precipitation processing and SISCAPA-type processing steps. Rather than measure an intact protein directly by mass spectrometry, SISCAPA makes use of proteolytic digestion (e.g., with the enzyme trypsin) to cleave sample proteins into smaller peptides ideally suited to quantitation by mass spectrometry. By selecting a target peptide whose sequence occurs only in the selected target protein (a so-called “proteotypic” peptide), the target peptide can serve as a direct quantitative surrogate for the target protein.

FIG. 9 shows a flow chart illustrating the process steps for preparing a diagnostic reagent mixture that can be used to evaluate the dispensing volume of a selected pipettor according to an embodiment of the invention. Reference can be made to FIG. 1 and FIG. 2A. In step 902, a reagent pack containing a first diagnostic reagent comprising an analyte, and a second diagnostic reagent comprising an antibody or antigen, is loaded into the presentation unit 401 in the automatic analyzer 400. In step 904 one of the pipettors 404, 405, 406, 407 delivers a requested volume of the first diagnostic reagent into a fluid container 103 provided by the bulk vessel feeder 403. In step 906, another of the pipettors 404, 405, 406, 407 delivers a requested volume of the second diagnostic reagent into the same fluid container 103. The mixture of diagnostic reagents in the fluid container 103 may be mixed using any suitable mixing process. In step 908, the fluid container 103 containing the mixture of reagents may be incubated to form an analyte-antibody or analyte-antigen complex. In step 910, the analyte-antibody complex or analyte-antigen complex is transferred to the mass spectrometer 106 to quantify the number of analyte-antibody or analyte-antigen complexes by molecular weight. In step 912, a bias is calculated based on the ratio of the measured signals from the mass spectrometer to the expected signals. Dispensing volume inaccuracies are detected in the selected pipettor being evaluated if the measured signal does not meet a certain threshold, such as 90% of the expected signals. If inaccuracies are detected, the dispensing volume of the selected pipettor requires adjustment. In step 914, a factor of 1/bias value is applied to the actuator for the dispensing pump associated with the target pipettor, and the actuator is adjusted as necessary to correct the dispensing volume inaccuracy detected. In some embodiments, the actuator 415 can be a stepper motor.

The clinical laboratory automation system 100 according to various embodiments may be used to measure or determine the presence of a variety of analytes, such as hormones, drugs of abuse, and tumor markers in one or more samples. For many of these analytes, the clinical laboratory automation system 100 can provide automated calibration using a single calibrator to prepare one or more calibrator dilutions used to generate a calibration curve for the quantitative measurement of the target analyte.

Additional examples are provided below.

### EXAMPLES

### Example 1: Single Thyroid-Stimulating Hormone Calibrator Dilution

Measuring thyroid-stimulating hormone (TSH) is useful in assessing thyroid function and monitoring patients undergoing thyroid replacement therapy. TSH is part of the hypothalamic-pituitary-thyroid axis that regulates the body's metabolism. The hypothalamus secretes a thyrotropin-releasing hormone (TRH), stimulating the pituitary gland to secrete TSH. TSH causes the release of thyroid hormones, T3 (triiodothyronine) and T4 (thyroxine), which control metabolic functions within the cells. When excessive amounts of T3 or T4 circulate, production of TRH stops, resulting in the process being controlled by a negative feedback loop.

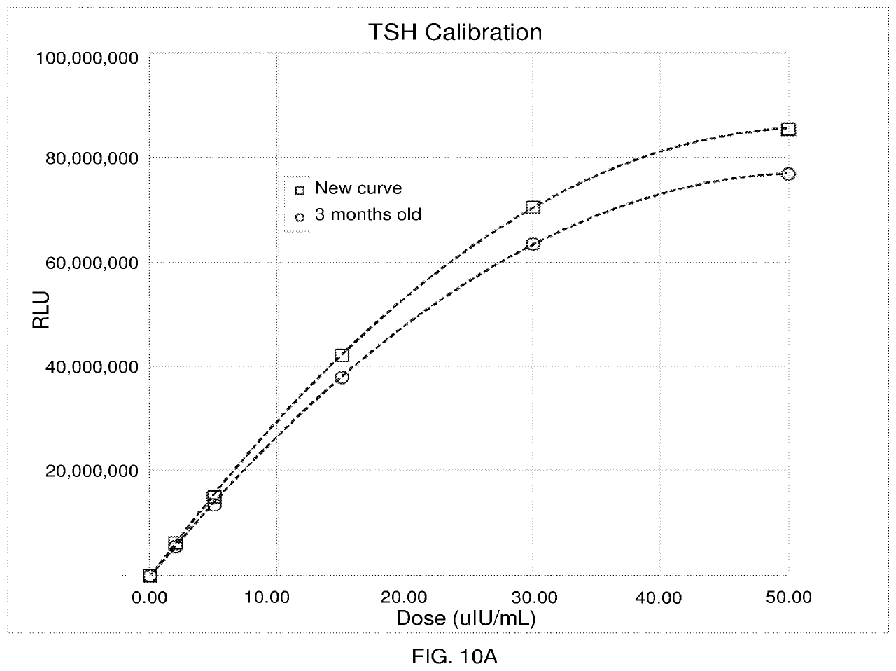

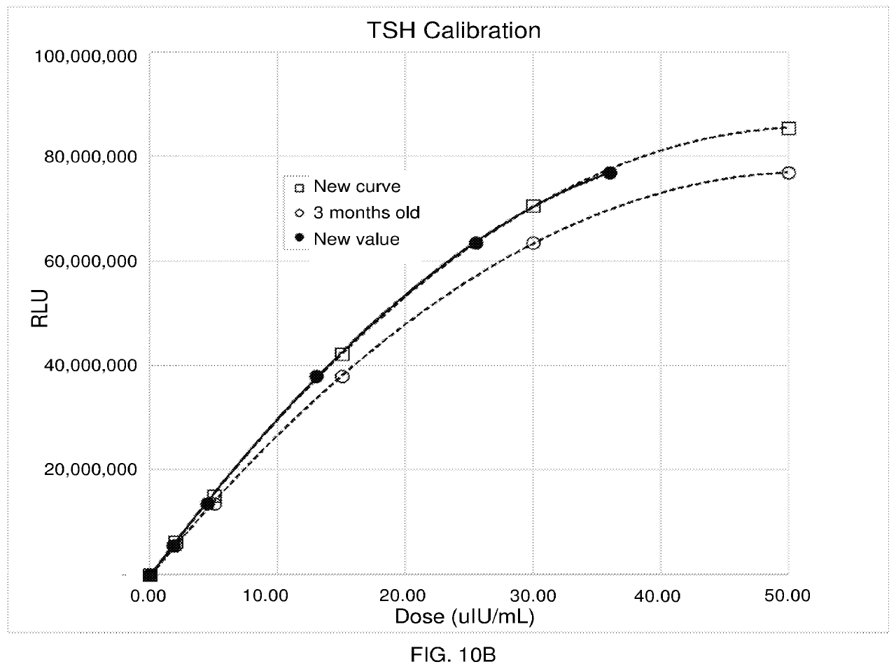

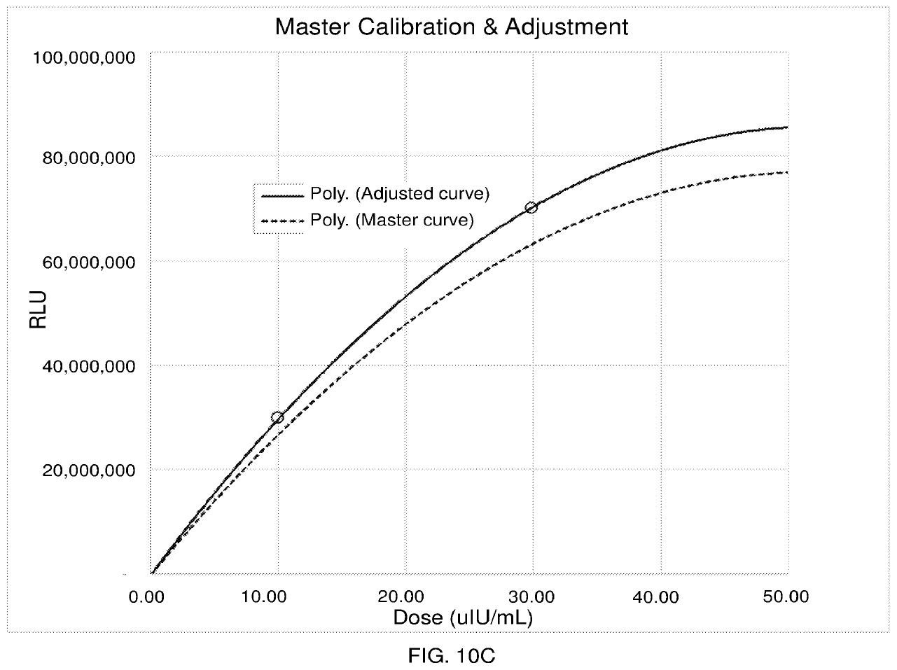

Quantitative analysis of the TSH in a patient sample requires a preliminary calibration of the instrumental response of the instrumentation and equipment used to detect the quantity of TSH in the sample analyzed. Calibration is usually performed with known concentrations of the target analytes present in the sample to be analyzed. The known concentrations can be used to construct a calibration curve that graphically plots the mathematical relationship between the measured response and the known analyte concentrations. One difficulty that can occur is that the calibration signals (i.e., Relative Light Units) can deteriorate over time while the assigned dose values remain the same. This difficulty is shown in FIG. 10A.

A new calibration curve can be prepared by the following method. A single calibrator TSH is loaded on a fluid handling system integrated with an immunoassay analyzer. A series of dilutions are created by first dispensing the diluent and then dispensing the calibrator. The diluted TSH calibrator is then sent to a mass spectrometer. The concentration of each calibrator dilution is quantified on the mass spectrometer, and an assigned measured concentration for each calibrator dilution provided on the immunoassay analyzer. A new calibration curve, represented in FIG. 10B, is then drawn on the immunoassay analyzer.

### Example 2: Master Calibration Curve Adjustment

For some embodiments, a manufacturer may create a master calibration curve for a clinical laboratory automation system at the manufacturing facility. The manufacturer provides the customer with particular calibration information, such as a bar code or 2D code, attached to a reagent package, and one or two adjustment calibrators. A user can test the calibrators on their own analyzer, and then adjust RLU-dose calibration curve on site, based on the values generated for the calibrators. FIG. 10C illustrates this adjustment.

### Example 3: Pipettor Dispense Volume Adjustment

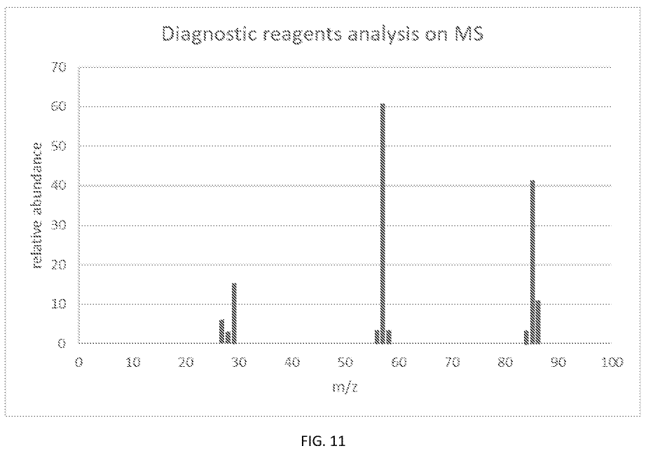

A fluid handler loads two diagnostic reagents on an immunoassay analyzer. The first diagnostic reagent comprises an analyte and the second diagnostic reagent comprises an antibody. A mixture of the two diagnostic reagents is created, with the amount of one of the two diagnostic reagents being significantly larger than the other diagnostic reagent. The mixture is then sent to a mass spectrometer. The mass spectrometer quantifies the number of analyte-antibody complex by molecular weight shift (FIG. 11), and a bias is calculated of the measured/expected signal. If the measurement is not within a predetermined threshold, a factor (=1/bias) is applied to the target pipettor motor steps.

### Example 4: Testosterone

An Access Testosterone assay kit (commercially available from Beckman Coulter, Inc., Brea, CA) can be used for the initial testing for testosterone in a biological sample. The assay can be run on the immunoassay analyzer of the sample processing system. The Access Testosterone assay is a competitive binding immunoenzymatic assay, using a mouse monoclonal anti-testosterone antibody, a testosterone alkaline phosphatase conjugate, and paramagnetic particles coated with a goat anti-mouse polyclonal antibody. Testosterone in the sample is released from the carrier proteins and competes with the testosterone alkaline phosphatase conjugate for binding sites on a limited amount of specific anti-testosterone monoclonal antibodies. The resulting antigen-antibody complexes are then bound to the solid phase by the capture antibody. After incubation in a reaction vessel, materials bound to the solid phase are held in a magnetic field while unbound materials are washed away. Then, the chemiluminescent substrate Lumi-Phos*530 is added to the vessel, and light generated by the reaction is measured with a luminometer. The light production is inversely proportional to the concentration of testosterone in the sample. The amount of the analyte in the sample is determined from a stored, multi-point calibration curve generated from mass spectrometer measurements of a calibrator dilution series prepared from a high concentration calibrator in the Access Testosterone kit.

### Example 5: Amphetamines

The clinical laboratory automation system according to an embodiment of the disclosure can be used to test for drugs of abuse. One exemplary drug of abuse type is amphetamines. Amphetamines are central nervous system stimulants that produce wakefulness, alertness, increased energy, reduced hunger, and an overall feeling of well-being.

Amphetamines appear in urine within three hours after any type of administration and can be detected by the Emit® II plus amphetamines assay (commercially available from Beckman Coulter, Inc., Brea, CA) for as long as 24-48 hours after the last dose. The Emit® II plus amphetamines assay is a homogeneous enzyme immunoassay. The assay is based on a competition between a drug in the specimen and a drug labeled with the enzyme glucose-6-phosphate dehydrogenase (G6PDH) for antibody binding sites. Enzyme activity decreases upon binding to the antibody, so the drug concentration in the specimen can be measured in terms of enzyme activity. Active enzymes convert nicotinamide adenine dinucleotide (NAD) to NADH, resulting in an absorbance change measured spectrophotometrically. Endogenous serum G6 PDH does not interfere because the coenzyme NAD functions only with the bacterial (Leuconostoc mesenteroides) enzyme employed in the assay.

The reagents used in the test can include mouse monoclonal antibodies to d-amphetamine (61 μg/mL) and d-methamphetamine (10 μg/mL), glucose-6-phosphate (5.5 mM), nicotinamide adenine dinucleotide (3.5 mM), bovine serum albumin, amphetamines labeled with bacterial G6PDH (0.72 U/mL), Tris buffer, preservatives, and stabilizers. Process samples are analyzed and compared with an assay threshold generated from mass spectrometer measurements of calibrator dilutions prepared from a calibrator in the assay kit, in accordance with an exemplary embodiment.

### Example 6: Cardiac Disease and Stroke

In some embodiments, the clinical laboratory automation system can be used to detect the risk of having cardiac disease or a stroke. Many forms of cardiovascular diseases begin with atherosclerosis, a condition where the arteries become hardened and narrowed due to plaque build-up around the artery wall. Plaque-made of cholesterol, fatty substances, cellular waste products, calcium, and fibrin—may partially or totally block the blood's flow through an artery in the heart, brain, pelvis, legs, arms, or kidneys. This blockage may develop into serious diseases, such as coronary heart disease, chest pain, carotid artery disease, peripheral artery disease (PAD), and chronic kidney disease. Even worse, if a piece of the plaques breaks off or a blood clot (thrombus) forms on the plaque's surface, a heart attack or stroke may result.

A number of lipoprotein markers are good biomarkers for cardiac disease, and a stroke can be measured from bodily fluid samples collected from the patient, e.g., blood, plasma, serum, using the mass spectrometer. These markers include B-type natriuretic peptide (BNP), proBNP (a non-active prohormone that produces BNP), human C-reactive protein (hs-CRP), and pregnancy associated plasma protein-A (PAPP-A). Many of these natriuretic peptides can aid in the determination of plaque progression and risk of onset stroke. Other markers include triglyceride to HDLp (high density lipoproteins) ratio, lipophorin-cholesterol ratio, lipid-lipophorin ratio, LDL cholesterol level, HDLp and apolipoprotein levels, lipophorins and LTPs ratio, sphingolipids, Omega-3 Index, and ST2 levels, which can be assayed using the mass spectrometer or analyzer component of the automation system. Quantitative measurements can be determined based on calibration curves generated from mass spectrometer measurements of calibrator dilutions. The measurements can be compared with reference ranges according to pre-established rules to determine the risk of cardiac disease or stroke.

If a small subset of the tumor markers is indicated as being positive according to the mass spectrometer data, the control system in the sample processing system then instructs the sample preparation module in the immunoassay analyzer to prepare and process a second aliquot of sample. The immunoassay analyzer then detects the subset of tumor markers using a multiplex, fluorescence-based sandwich immunoassay. The assay can involve adding to the sample aliquot primary antibodies that are specific to respective tumor markers in the subset and detection antibodies that are conjugated to fluorophores and can recognize each of the primary antibodies. The fluorophores have different excitation and emission wavelengths, so that fluorescent signals from the detection antibodies will not interfere with one another. The fluorescent signal from each of the detection antibodies is measured, which represents the amount of each of the corresponding tumor markers in the sample. The results of the tumor markers that are determined to be positive by the immunoassay analyzer are then reported.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

All patents, patent applications, publications, and descriptions mentioned above are herein incorporated by reference in their entirety.

1. A clinical laboratory automation system (100) comprising:
a fluid handling system (104) including a container handler (101), at least one fluid container (103), and a pipettor arrangement (421), the fluid handling system (104) configured to dispense at least one fluid into the at least one fluid container;
an analyzing component (102); and
a mass spectrometer (106) configured to evaluate at least a characteristic of the at least one fluid, and thereby produce a corresponding set of values,
wherein the analyzing component (102) is calibrated at least in part using the corresponding set of values.

2. The clinical laboratory automation system (100) of claim 1, wherein the clinical laboratory automation system (100) is further configured to evaluate for dispensing inaccuracies in the pipettor arrangement (421) using at least the corresponding set of values.

3. The clinical laboratory automation system (100) of claim 1, wherein the analyzing component (102) includes an immunoassay analyzer.

4. The clinical laboratory automation system (100) of claim 1, wherein the analyzing component (102) includes a clinical chemistry analyzer, protein chemistry analyzer, hematology analyzer, or urinalysis analyzer.

5. The clinical laboratory automation system (100) of claim 1, wherein the clinical laboratory automation system further includes a sample pipettor station (402a)

6. The clinical laboratory automation system (100) of claim 1, wherein the pipettor arrangement (421) comprises a pump (414), wherein the pump (414) is driven by an actuator (415).

7. The clinical laboratory automation system (100) of claim 6, wherein the actuator is a motor.

8. The clinical laboratory automation system (100) of claim 7, wherein the motor is a stepper motor.

9. The clinical laboratory automation system (100) of claim 1, wherein the at least one fluid is selected from the group consisting of a calibrator, a diagnostic reagent, a diluent, or mixtures thereof.

10. The clinical laboratory automation system (100) of claim 9, wherein the calibrator contains at least one type of analyte or antibody.

11. The clinical laboratory automation system of claim 9, wherein the calibrator contains a plurality of different types of analytes and/or antibodies.

12. The clinical laboratory automation system (100) of claim 9, wherein the calibrator or the diagnostic reagent comprises an analyte, the analyte independently selected from the group consisting of thyroid-stimulating hormone (TSH), prostate-specific antigen (PSA), troponin, vitamin D, and Free thyroxine (T4).

13. The clinical laboratory automation system (100) of claim 9, wherein the diagnostic reagent comprises an antibody or an antigen.

14. The clinical laboratory automation system (100) of claim 9, wherein the diluent is a TRIS buffer or a Bovine Serum Albumin (BSA) buffer.

15. The clinical laboratory automation system (100) of claim 1, wherein the corresponding set of values includes a single value.

16. The clinical laboratory automation system (100) of claim 5, wherein the pipettor arrangement further comprises at least a first pipettor (404), wherein the first pipettor (404) is configured to dispense at least one requested volume of a fluid.

17. The clinical laboratory automation system (100) of claim 16, wherein the fluid handling system (104) is configured to dispense at least two fluids, preferably a first fluid and a second fluid.

18. The clinical laboratory automation system (100) of claim 17, wherein the first pipettor (404) is configured to dispense either a first requested volume of the first fluid or a second requested volume of the second fluid into the same fluid container.

19. The clinical laboratory automation system (100) of claim 16, wherein the pipettor arrangement further comprises at least a second pipettor (405), wherein the first pipettor (404) is configured to dispense a first requested volume of a first fluid into a fluid container and the second pipettor (405) is configured to dispense a second requested volume of a second fluid into the same fluid container.

20. The clinical laboratory automation system (100) of claim 16, wherein the first pipettor (404) is configured to dispense a first requested volume of a first fluid into a fluid container, and the sample pipettor station (402a) is configured to dispense a second requested volume of a second fluid into the same fluid container.

21. The clinical laboratory automation system (100) of claim 17, wherein the first fluid is the diluent and the second fluid is the calibrator.

22. The clinical laboratory automation system (100) of claim 21, wherein the fluid handling system (104) is configured to produce a dilution series of the calibrator, the dilution series comprising at least one dilution of the calibrator.

23. The clinical laboratory automation system (100) of claim 22, wherein the characteristic evaluated is a concentration of the at least one dilution of the calibrator from the set of the dilution series of the calibrator.

24. The clinical laboratory automation system (100) of claim 23, wherein an RLU-dose conversion curve is generated from the corresponding set of values and the analyzing component is calibrated at least in part using the RLU-dose conversion curve.

25. The clinical laboratory automation system (100) of claim 23, wherein the clinical laboratory automation system (100) includes an RLU-dose master calibration curve, and the corresponding set of values is used to generate an adjusted calibration curve.

26. The clinical laboratory automation system (100) of claim 17, wherein the first fluid is a first diagnostic reagent and the second fluid is a second diagnostic reagent.

27. The clinical laboratory automation system (100) of claim 26, wherein the first diagnostic reagent comprises an analyte and the second diagnostic reagent comprises an antibody or an antigen.

28. The clinical laboratory automation system (100) of claim 27, wherein the characteristic evaluated is a quantitation of a mixture of the first diagnostic reagent and the second diagnostic reagent.

29. The clinical laboratory automation system (100) of claim 28, wherein the quantitation of the mixture of diagnostic reagents comprises quantifying the mixture of the first diagnostic reagent and the second diagnostic reagent by molecular weight shift.

30. The clinical laboratory automation system (100) of claim 29, wherein if the dispensing inaccuracies are determined, motor steps of the actuator (107) are adjusted as necessary to dispense the respective volumes.

31. The clinical laboratory automation system (100) of claim 29, wherein if the dispensing inaccuracies are determined, the pipettor arrangement is calibrated at least in part with the corresponding set of values.

32. The clinical laboratory automation system (100) of claim 1, wherein at least a portion of the fluid handling system (104) is integrated with the analyzing component (102).

33. The clinical laboratory automation system (100) of claim 1, wherein at least a portion of the fluid handling system (104) is integrated with the mass spectrometer (106).

34. The clinical laboratory automation system (100) of claim 1, wherein the clinical laboratory automation system (100) further comprises a control system (108) configured to control the fluid handling system (104), the analyzing component (102) and/or the mass spectrometer (106).

35. A method of calibrating an immunoassay analyzer or clinical chemistry analyzer, the method comprising the steps of:
providing a clinical laboratory automation system (100), the clinical laboratory automation system (100), comprising:
(a) a fluid handling system (104) including a container handler (101), at least one fluid container (103), and a pipettor arrangement (421), the pipettor arrangement (421) comprising at least a first pipettor (404) and at least a second pipettor (405),
wherein the first pipettor (404) is configured to dispense a first requested volume of a first fluid into a fluid container (103) and the second pipettor (405) is configured to dispense a second requested volume of a second fluid into the same fluid container (103);
wherein the first fluid is a diluent and the second fluid is a calibrator;
the fluid handling system (104) configured to produce a dilution series of at least the second fluid, the dilution series comprising at least one dilution of the at least the second fluid;
(b) an immunoassay analyzer or a clinical chemistry analyzer; and
(c) a mass spectrometer (106) configured to evaluate a concentration of at least one dilution from a set of the dilution series of the calibrator and generate a corresponding set of values;
wherein an RLU-dose conversion curve is generated from the corresponding set of values and the immunoassay analyzer or the clinical chemistry analyzer is calibrated at least in part using the RLU-dose conversion curve.

36. A method of adjusting a pipettor dispensing volume, the method comprising the steps of:
providing a clinical laboratory automation system (100), the clinical laboratory automation system (100) comprising:
(a) a fluid handling system (104) including a container handler (101), at least one fluid container (103), and a pipettor arrangement (421), the pipettor arrangement comprising (421) at least a first pipettor (404), at least a second pipettor (405), and a pump (414), wherein the pump (414) is driven by an actuator (415);
wherein the first pipettor (404) is configured to dispense a first requested volume of a first fluid into a fluid container and the second pipettor (405) is configured to dispense a second requested volume of a second fluid into the same fluid container (103);
wherein the first fluid is a first diagnostic reagent and the second fluid is a second diagnostic reagent, and the first diagnostic reagent comprises an analyte and the second diagnostic reagent comprises an antibody or an antigen;
(b) an immunoassay analyzer or a clinical chemistry analyzer; and
(c) a mass spectrometer (106) configured to quantify of a mixture of the first diagnostic reagent and second diagnostic reagent and thereby produce a corresponding set of values; and
the clinical laboratory automation system (100) is further configured to evaluate for dispensing inaccuracies in the pipettor arrangement (421) using at least the corresponding set of values, wherein if dispensing inaccuracies are determined, the actuator (415) is adjusted as necessary to dispense the respective volumes.

37. A method for providing a variable dilution of a fluid, the method comprising:
providing a fluid handling system (104), wherein the fluid handling system (104) includes a container handler (101), at least a first fluid container (103), and a pipettor arrangement (421), the pipettor arrangement comprising at least a first pipettor (404) and a second pipettor (405), the fluid handling system (104) configured to produce a set of dilution series of a calibrator;
providing a calibrator;
providing a diluent;
diluting the calibrator into a dilution by:
dispensing a requested first volume of the diluent into a first fluid container (103) with the pipettor arrangement (421); and
dispensing a requested first volume of the calibrator into said first fluid container (103) with the pipettor arrangement (421).

38. The method of claim 37, wherein the fluid handling system (104) includes at least a second fluid container (103a) wherein the method further comprises:
dispensing a requested second volume of the diluent into a second fluid container with the pipettor arrangement (421); and
dispensing a requested second volume of the calibrator into said second fluid container (103a) with the pipettor arrangement (421).

39. The method of claim 38, wherein the fluid handling system (104) includes at least a third fluid container (103b) wherein the method further comprises:
dispensing a requested third volume of the diluent into a third fluid container (103b) with the pipettor arrangement (421); and
dispensing a requested third volume of the calibrator into said third fluid container (103b) with the pipettor arrangement (421).

40. The method of claim 39, wherein the fluid handling system (104) includes at least a fourth fluid container (103c) wherein the method further comprises:
dispensing a requested fourth volume of the diluent into a fourth fluid container (103c) with the pipettor arrangement (421); and
dispensing a requested fourth volume of the calibrator into said fourth fluid container (103c) with the pipettor arrangement (421).

41. A method of calibrating an immunoassay analyzer or clinical chemistry analyzer, the method comprising the steps of:
providing a clinical laboratory automation system (100), the clinical laboratory automation system (100), comprising:
(a) a fluid handling system (104) including a container handler (101), at least one fluid container (103), and a pipettor arrangement (421) comprising at least a first pipettor (404),
(b) a sample pipettor station (402a);
(c) an immunoassay analyzer or a clinical chemistry analyzer; and
(d) a mass spectrometer (106);
dispensing, from the first pipettor (404) in the pipettor arrangement (421), a first requested volume of a diluent fluid into the fluid container (103),
dispensing, from the sample pipettor station (402a), a requested volume of a calibrator into the same fluid container to produce a dilution series comprising at least one dilution of the calibrator;
performing, by the mass spectrometer (106), an evaluation of the concentration of the at least one dilution of the calibrator from the dilution series, and generating a corresponding set of values to thereby generate an RLU-dose calibration curve;
and calibrating the immunoassay analyzer or clinical chemistry analyzer using, at least in part, the RLU-dose calibration curve.

42. A method for providing a variable dilution of a fluid, the method comprising:
providing a sample pipettor station (402a) and a fluid handling system (104), wherein the fluid handling system (104) includes a container handler (101), at least a first fluid container (103), and a pipettor arrangement (421), the pipettor arrangement comprising at least a first pipettor (404), the fluid handling system (104) configured to produce a set of dilution series of a calibrator;
providing a calibrator;
providing a diluent;
diluting the calibrator into a dilution by:
dispensing a requested first volume of the diluent into a first fluid container (103) with the first pipettor (404) in the pipettor arrangement (421); and
dispensing a requested volume of the calibrator into said first fluid container (103) with the sample pipettor station (402a).
